(19) United States
(12) Patent Application Publication
(10) Pub. No.: US 2011/0010183 A1
(43) Pub. Date: Jan. 13, 2011

(54) SYSTEM AND METHOD FOR PROVIDING MARKET SURVEY ANALYSIS

(75) Inventors: Anne Manning, Charlestown, MA (US); William Mount, Boston, MA (US)

Correspondence Address: SHEEHAN PHINNEY BASS & GREEN, PA;c/o PETER NIEVES, 1000 ELM STREET, MANCHESTER, NH, 03105-3701, US

(73) Assignee: Drumcircle LLC, Charlestown, MA (US)

(21) Appl. No.: 12/783,269

(22) Filed: May 19, 2010

Related U.S. Application Data
(60) Provisional application No. 61/179,453, filed on May 19, 2009.

(51) Int. Cl. G06Q 10/00

(52) U.S. Cl. 705/1.1

(57) ABSTRACT

Provided is a method for conducting a market survey, including identifying a survey topic and administrating the survey to a survey participant. The survey includes requesting the participant to enter text expressing an emotion regarding a topic of the survey. The survey also requests the participant enter a metric indicating the level of emotional intensity in relation to the text expressing an emotion. The survey administrator correlates an emotionally based theme to the emotion expressing text, and assigns a second emotion measuring metric to the emotionally based theme. The administrator may additionally present a set of images to the survey participant and request the participant to select an image to associate with the text expressing an emotion.

### CROSS-REFERENCE TO RELATED APPLICATION

This application claims priority to copending U.S. Provisional Patent Application entitled “System and Method for Providing Market Survey Analysis,” having Ser. No. 61/179,453, filed May 19, 2009, which is hereby incorporated by reference herein in its entirety.

### FIELD OF THE INVENTION

The present invention is generally related to marketing, and more particularly is related to a system and method for market survey analysis.

### BACKGROUND

Providers of goods and services are naturally very interested in better understanding the needs of their customers. Good marketing tools uncover how people feel about things, link those feelings to purchase decisions, and shape marketing programs. Marketing programs may result in better communication with customers or may produce better goods and services. Better communication and better goods and services can mean increased customer loyalty and increased revenue for the providers of those goods and services. There is therefore a need for marketing tools that are adept at uncovering feelings linked to purchase decisions.

Whereas it was previously thought that people make decisions by thinking about what they will do, doing it, and then having feelings about what they have done, contemporary psychologists and neuroscientists such as Antonio Damasio, Dr. Robert Plutchik, and Stephen Pinker teach that, in making decisions, people are in fact first motivated by feelings, and these feelings are then post-rationalized by thinking. This process happens so quickly and at such a deep level that the person making the decision is usually completely unaware of the process. Unfortunately, many conventional marketing techniques are based on the old understanding, or what might be referred to as rational thinking. Marketing techniques reflecting the new understanding, or what might be referred to as rationale thinking, are therefore desired, because such rationale-thinking-based marketing techniques can be better expected to uncover the emotional motivations that make people purchase one product or service over another.

Moreover, there is frequently a disconnect or lack of clear correspondence between so-called right brain versus left-brain marketing analyses. Even decision makers at the organizations providing goods and services may find it difficult to relate impressionistic or feeling-based information, such as that which might be conveyed through use of images, to logical or verbal information, such as that which might be conveyed through use of text. There is therefore a need for market survey analysis that clarifies the connection between these two modes of understanding and thus facilitates communication and understanding on the part of marketing executives and other decision makers.

Thus, a heretofore unaddressed need exists in the industry to address the aforementioned deficiencies and inadequacies.

### SUMMARY

Accordingly, a first aspect of the present invention is directed to a method for conducting a market survey. A survey topic is identified, and the survey is administered on the survey topic to a survey participant, wherein administration of the survey includes requesting the survey participant to enter emotion expressing text, and requesting the survey participant to enter a first emotion-intensity measuring metric. The first emotion-intensity measuring metric relates the emotional response level of the survey participant to the emotion expressing text.

Another step of the method is accepting a survey entry by the survey participant, wherein the survey entry includes the emotion expressing text and the first emotion-intensity measuring metric. Other steps include correlating an emotionally based theme to the emotion expressing text, and assigning a second emotion-intensity measuring metric to the emotionally based theme based upon the first emotion-intensity measuring metric.

The step of administering the survey may further include the steps of displaying a predetermined set of images to the survey participant, and requesting the survey participant to select an image from the predetermined set of images. The survey entry may include an image selected from the predetermined set of images. The step of requesting the survey participant to enter emotion expressing text may further include the step of presenting a predetermined set of emotion expressing text to the survey participant. The second emotion-intensity measuring metric may be a number in the range from −6 to +6, or may be a number in the range from −10 to +10. The first emotion-intensity measuring metric may include a word, and the word may be selected from the group consisting of: dejected, angry, sad, disturbed, nervous, bored, indifferent, interested, confident, surprised, happy, delighted, and ecstatic.

The step of administrating the survey may include the additional steps of asking a survey question regarding the survey topic in relation to an ideal market scenario, asking a survey question regarding the survey topic in relation to a typical market scenario, and asking a survey questions regarding the survey topic in relation to a specific market scenario. The step of requesting the survey participant to enter emotion expressing text may further include the step of displaying a fill-in-the-blank statement to the survey participant. The emotion expressing text may be a single word.

A second aspect of the current invention is a method for conducting a market survey and processing the resulting data, including these steps: determining a survey topic, collecting survey data, extracting an emotionally based theme from the survey data, coding the survey data based upon the emotionally based theme, and outputting coded results. The step of collecting survey data may further contain the steps of: requesting a survey participant to enter emotion expressing text, requesting a survey participant to generate an emotion intensity metric, and outputting raw data. The step of collecting survey data may further include the steps of displaying images and requesting a survey participant to select an image from the displayed images.

A third aspect of the current invention is a system for collecting, processing and presenting market survey data relating the emotional response of a survey participant to a survey topic. This system contains a survey topic identification module and a survey administration module including a text entry module wherein the survey participant enters text representing an emotion expressing text, and an emotion intensity metric module wherein the survey participant enters a first emotional intensity metric. The system also contains an emotionally based theme extraction module wherein the emotionally based theme extraction module associates an emotionally based theme with the emotion expressing text. The emotionally based theme is selected from a predetermined list of emotionally based themes. The system further includes a data coding module wherein a second emotional intensity metric is assigned to the emotionally based theme based upon the emotion expressing text and the first emotion intensity metric, and a results presentation module.

The survey administration module may further contain an image selection module wherein the survey participant selects an image from a predetermined set of images. The first emotional intensity metric may include a numeric value indicating the intensity of emotion associated with the emotion expressing text. The first emotional intensity metric may include a text description of the intensity of emotion associated with the emotion expressing text and the results presentation module may include a tabular listing module. The results presentation module may include a graphical comparison module, and the results presentation module may include an executive summary module.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a schematic diagram illustrating an example of a general-purpose computer and associated software for implementing the system and method for providing market survey analysis of the present invention.

FIG. 2 is a schematic diagram illustrating functional blocks representing functionality defined by the software at FIG. 1, in accordance with a first exemplary embodiment of the invention.

FIG. 3 is a flowchart of a method for providing market survey analysis in accordance with a first embodiment of the present invention.

FIG. 4 is a flowchart of a method for conducting a market survey, this market survey being conducted as part of the method for providing market survey analysis carried out in accordance with the flowchart of FIG. 3.

FIG. 5 shows tabular listing of coded data for one scenario in a market survey conducted in accordance with the flowchart of FIG. 4.

FIG. 6 shows graphical comparison of five emotionally based themes and four scenarios in a market survey conducted in accordance with the flowchart of FIG. 4.

### DETAILED DESCRIPTION

One aspect of the present invention is a system and method for conducting a market survey such as an online market survey involving selection of images and association of emotion-expressing text with the selected images. Another aspect of the present invention is a system and method for providing market survey analysis in which emotionally based themes that influence decisions made by human beings are extracted from responses to a market survey.

In accordance with one embodiment, the system and method of the present invention allow a market survey to be conducted and allow analysis to be performed on the data collected during the market survey. The present system and method may be provided by a Web-based application. The following description assumes that the present system and method is provided by a Web-based application. It should be noted that the system and method may also be provided in an environment that is not Web-based.

The market survey analysis system of the invention can be implemented in software (e.g., firmware), hardware, or a combination thereof. In the currently contemplated best mode, the market survey analysis system is implemented in software, as an executable program, and is executed by a special or general-purpose digital computer, such as a personal computer (PC; IBM-compatible, Apple-compatible, or otherwise), workstation, minicomputer, or mainframe computer. Specifically, the market survey analysis system, as provided by the computer, may be accessible via a Web site, through which parties using the market survey analysis system may interact. Further description of the market survey analysis system, and interaction therewith is provided below.

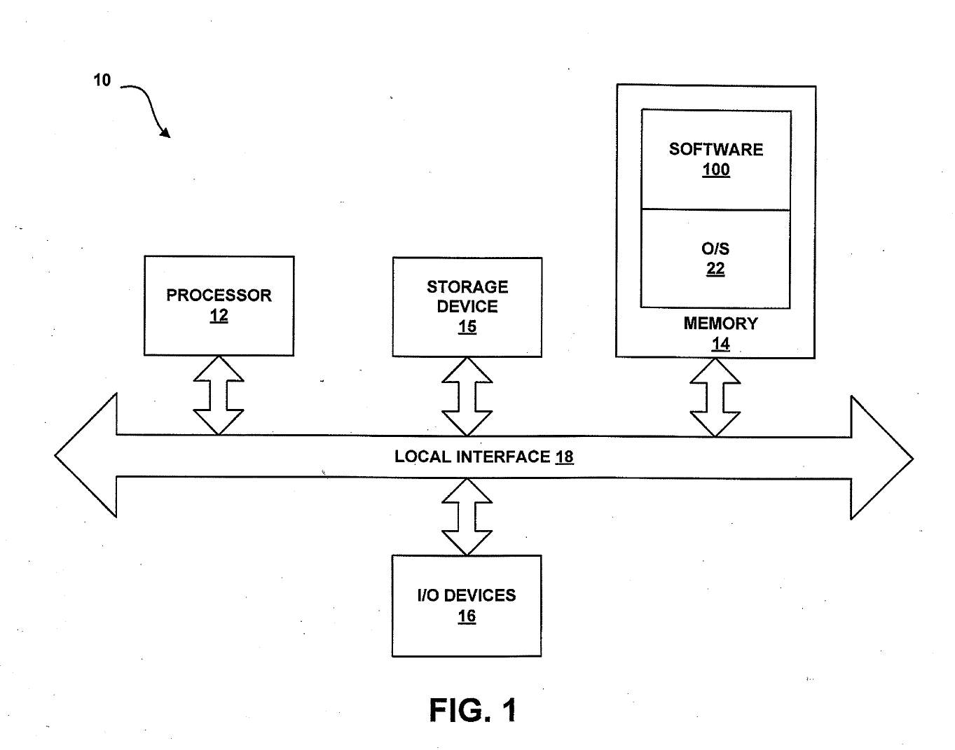

An example of a general-purpose computer that can implement the market survey analysis system of the present invention is shown in FIG. 1. In FIG. 1, the market survey analysis system is denoted by reference numeral 10. It should be noted that communication with the market survey analysis system may be provided by multiple means such as, but not limited to, the Internet. Further description with regard to use of the market survey analysis system via use of the Internet is provided below.

Generally, in terms of hardware architecture, as shown in FIG. 1, the computer 10 includes a processor 12, memory 14, storage device 15, and one or more input and/or output (I/O) devices 16 (or peripherals) that are communicatively coupled via a local interface 18. The local interface 18 can be, for example but not limited to, one or more buses or other wired or wireless connections, as is known in the art. The local interface 18 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 12 is a hardware device for executing software, particularly that stored in the memory 14. The processor 12 can be any custom made or commercially available processor, a central processing unit (CPU), an auxiliary processor among several processors associated with the computer 10, a semiconductor based microprocessor (in the form of a microchip or chip set), a macroprocessor, or generally any device for executing software instructions.

The memory 14 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 14 may incorporate electronic, magnetic, optical, and/or other types of storage media. Note that the memory 14 can have a distributed architecture, where various components are situated remote from one another, but can be accessed by the processor 12.

The software 100 in memory 14 may include one or more separate programs, each of which contains an ordered listing of executable instructions for implementing logical functions of the market survey analysis system, as described below. In the example of FIG. 1, the software 100 in the memory 14 defines the market survey analysis system functionality in accordance with the present invention. In addition, the memory 14 may contain an operating system (O/S) 22. The operating system 22 essentially controls the execution of computer programs and provides scheduling, input-output control, file and data management, memory management, and communication control and related services.

Instructions for implementing the market survey analysis system 10 may be provided by a source program, executable program (object code), script, or any other entity containing a set of instructions to be performed. When a source program, then the program needs to be translated via a compiler, assembler, interpreter, or the like, which may or may not be included within the memory 14, so as to operate properly in connection with the O/S 22. Furthermore, instructions for implementing the market survey analysis system 10 can be written as (a) an object oriented programming language, which has classes of data and methods, or (b) a procedure programming language, which has routines, subroutines, and/or functions.

The I/O devices 16 may include input devices, for example but not limited to, a keyboard, mouse, scanner, microphone, etc. Furthermore, the I/O devices 16 may also include output devices, for example but not limited to, a printer, display, etc. Finally, the I/O devices 16 may further include devices that communicate via both inputs and outputs, for instance but not limited to, a modulator/demodulator (modem; for accessing another device, system, or network), a radio frequency (RF) or other transceiver, a telephonic interface, a bridge, a router, etc.

When the market survey analysis system 10 is in operation, the processor 12 is configured to execute the software 100 stored within the memory 14, to communicate data to and from the memory 14, and to generally control operations of the computer 10 pursuant to the software 100. The market survey analysis system 10 and the O/S 22, in whole or in part, but typically the latter, are read by the processor 12, perhaps buffered within the processor 12, and then executed.

When the market survey analysis system 10 is implemented in software, as is shown in FIG. 1, it should be noted that instructions for implementing the market survey analysis system 10 can be stored on any computer-readable medium for use by or in connection with any computer-related system or method. Such a computer-readable medium may, in some embodiments, correspond to either or both the memory 14 or the storage device 15 shown in FIG. 1. In the context of this document, a computer-readable medium is an electronic, magnetic, optical, or other physical device or means that can contain or store a computer program for use by or in connection with a computer-related system or method. Instructions for implementing the market survey analysis system 10 can be embodied in any computer-readable medium for use by or in connection with the processor 12 or other such instruction execution system, apparatus, or device. Although the processor 12 has been mentioned by way of example, such instruction execution system, apparatus, or device may, in some embodiments, be any computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the processor 12 or other such instruction execution system, apparatus, or device.

Such a computer-readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the market survey analysis system 10 is implemented in hardware, the market survey analysis system 10 can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

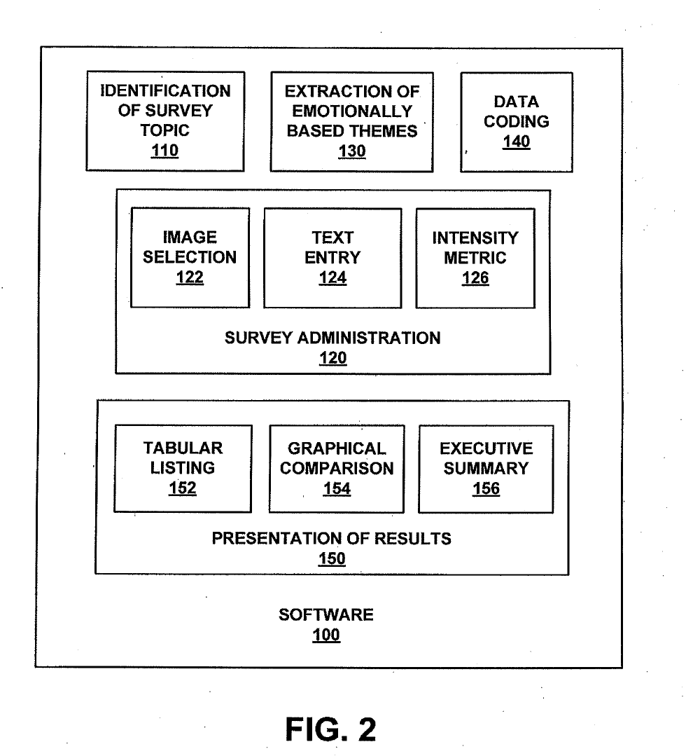

FIG. 2 is a schematic diagram illustrating functional blocks representing functionality defined by the software 100 of FIG. 1, in accordance with a first exemplary embodiment of the invention. In accordance with the present embodiment, the software 100 includes a survey topic identification module 110, a survey administration module 120, an emotionally based theme extraction module 130, a data coding module 140, and a results presentation module 150.

The survey topic identification module 110 may include functionality for identifying a market survey topic. In one embodiment, the survey topic identification module 110 interfaces with a client to determine client needs or otherwise identify a market survey topic. For example, the survey topic identification module 110 might receive an inquiry from a client, register the name and address of the client in a database at the storage device 15, inform the client as to the cost of carrying out market survey analysis, and accept entry from the client of text input indicating the desired market survey topic. In some embodiments, face-to-face meetings between the client and one or more marketing consultants might facilitate identification of the survey topic.

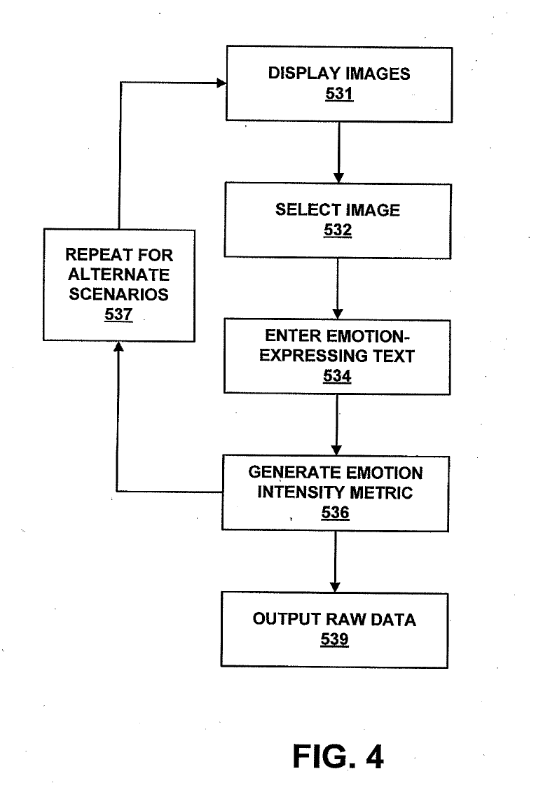

The survey administration module 120 may include functionality for administering a survey on a topic identified by the survey topic identification module 110. In one embodiment, the survey administration module 120 contains functionality for conducting a survey in accordance with the method of the flowchart of FIG. 4. The survey administration module 120 may, for example, contain functionality for conducting the survey in online fashion, e.g., over the Internet, so as to permit the survey to be taken by any number of survey participants.

As shown in FIG. 2, in one embodiment, the survey administration module 120 contains an image selection module 122, a text entry module 124, and an intensity metric module 126. Furthermore, in such an embodiment, the image selection module 122 contains functionality for displaying images to survey participants and for allowing selection of those images by survey participants. Moreover, in such an embodiment, the text entry module 124 contains functionality for accepting entry of text from survey participants and associating this text with images selected by survey participants at the image selection module 122.

In addition, in such an embodiment, the intensity metric module 126 contains functionality for accepting entry by a survey participant of an emotion-intensity-measuring word or for otherwise generating a metric, e.g., a number from −6 to +6, indicative of intensity of the emotion that the survey participant has in connection with image(s) selected at the image selection module 122 and/or text entered at the text entry module 124. It is furthermore preferred that the emotion intensity metric indicate whether such emotion is positive or negative.

As used herein, positive emotion refers to a favorable response such as liking or approval. Negative emotion as used herein refers to an unfavorable response such as disliking or disapproval. For example, at the intensity metric module 126, the survey participant might be asked to choose one from among a set of, for example, 13 emotion-intensity-measuring words, or semantic analysis might be carried out on text entered at the text entry module 124 in association with images selected at the image selection module 122 to generate the emotion intensity metric.

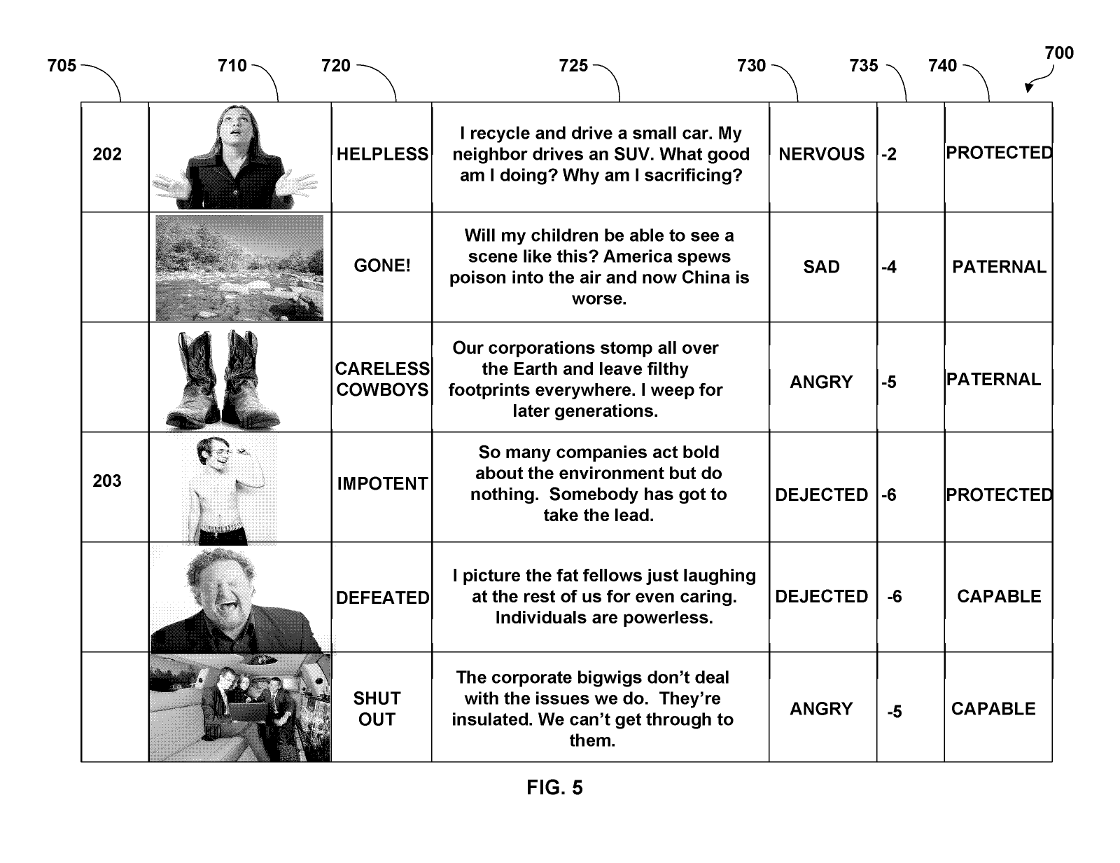

The emotionally based theme extraction module 130 may include functionality for extracting emotionally based themes from text entered by survey participants at the text entry module 124. In some embodiments, content of images selected by survey participants at the image selection module 122 may, where necessary or helpful, also be used by the emotionally based theme extraction module 130 during extraction of emotionally based themes from text entered by survey participants images at the text entry module 124. For example, one of skill in the art will readily appreciate that text entered by a survey participant at the text entry module 124 may in some situations, e.g., the situation shown in the second row of the tabular listing 700 at FIG. 5, only have meaning in the context of the image that was selected by the survey participant at the image selection module 122. On the other hand, in other situations, e.g., the situation shown in the sixth row of the tabular listing 700 at FIG. 5, text entered by the survey participant at the text entry module 124 may by itself, without the need to in addition refer to the image that was selected by the survey participant at the image selection module 122, be sufficient for extraction of emotionally based themes.

Emotionally based themes as used herein are overt or latent themes that motivate decisions, e.g., a decision to purchase or not purchase a good or service, made by human beings. An emotionally based theme may preferably be used to complete the sentence “my interaction with <TOPIC> affects how <BLANK> I feel,” where <TOPIC> here represents a survey topic, and <BLANK> here represents an emotionally based theme.

In one embodiment, the emotionally based theme extraction module 130 might carry out semantic analysis to extract emotionally based themes from text entered by survey participants at the text entry module 124, with or without referring for context to the images selected by survey participants at the image selection module 122. In some embodiments, extraction of emotionally based themes might be facilitated by enlisting the cooperation of human beings charged with the task of finding emotionally based themes present in the market survey data that has been output in tabular form in similar fashion as that output by the tabular listing module 152, described below (but note that whereas the exemplary tabular listing shown in FIG. 5, described below as an example of coded output produced by the tabular listing module 152, contains emotionally based themes 740, market survey data from which emotionally based themes are to be extracted by the emotionally based theme extraction module 130 or as facilitated by human beings would of course not yet be coded by emotionally based theme).

The data coding module 140 may include functionality for coding survey data by emotionally based theme. Following extraction by the emotionally based theme extraction module 130 of a suitable number, e.g., five, emotionally based themes from text entered by survey participants at the text entry module 124 with or without referring for context to the images selected by survey participants at the image selection module 122, the data coding module 140 may categorize each response from each survey participant as corresponding to one of the five extracted emotionally based themes. The data coding module 140 may furthermore include functionality for characterizing each response from each survey participant as having an emotional intensity as indicated by the emotion intensity metric entered by the survey participant or otherwise generated at the intensity metric module 126.

The results presentation module 150 may include functionality for presenting the results of market survey analysis. For example, the results presentation module 150 might include a tabular listing module 152 containing functionality for presenting, in tabular listing format, the market survey data coded at the data coding module 140. This tabular listing format might be such that each row therein corresponds to an image selected by a survey participant at the image selection module 122, the image being shown together with the text that the survey participant associated with that image at the text entry module 124, the intensity metric entered by the survey participant or otherwise generated at the intensity metric module 126, and the emotionally based theme extracted at the emotionally based theme extraction module 130.

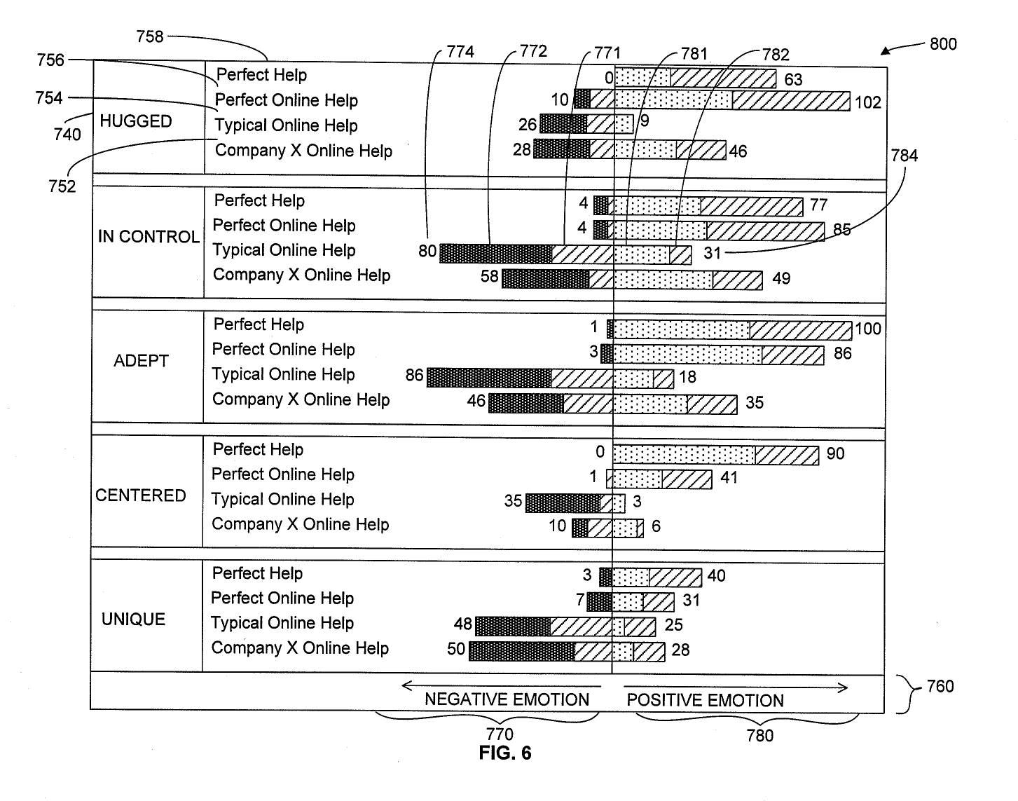

Alternatively or in addition thereto, the results presentation module 150 might include a graphical comparison module 154 containing functionality for presenting, in graphical comparison format, the market survey data coded at the data coding module 140. This graphical comparison format might be such as to show in graphical or pictorial form the number of responses, and range of emotional intensity in those responses, coded at the data coding module 140 as reflecting the respective emotionally based themes extracted at the emotionally based theme extraction module 130. Examples of output from the tabular listing module 152 and the graphical comparison module 154 are respectively shown in FIGS. 5 and 6 and are described in further detail below.

Alternatively or in addition thereto, the results presentation module 150 might include an executive summary module 156 containing functionality for presenting an executive summary of the market survey data. This executive summary might be suitable for presentation to an advertising agency, a product development team, a group of designers, or a public relations firm, and might complete the following sentences: (1) I want to feel <BLANK>. (2) You can make me feel that way by <BLANK>. (3) I will believe you if you <BLANK>. Here, in each of the foregoing three sentences, <BLANK> represents content derived from the market survey data. In some embodiments, enlisting the cooperation of human beings charged with this task might facilitate completion of these three sentences.

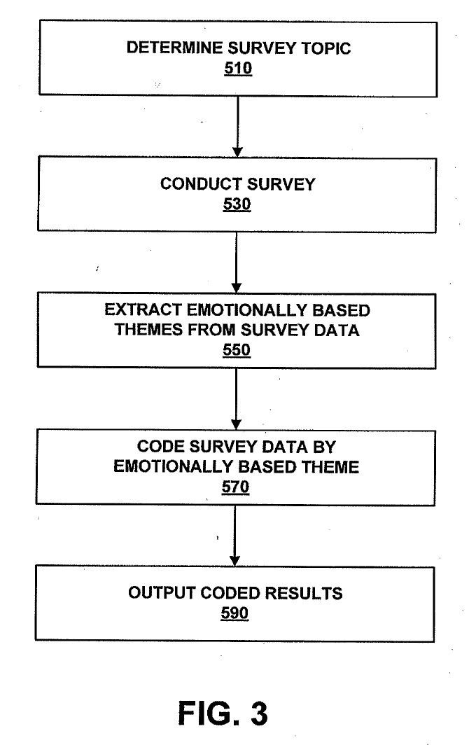

FIG. 3 is a flowchart showing a method for providing market survey analysis in accordance with a first embodiment of the present invention. The method in the flowchart of FIG. 3 may be carried out entirely automatically, may be carried out entirely manually, or may be carried out partially automatically and partially manually.

At block 510 of the flowchart shown in FIG. 3, a survey topic is determined. For example, in an embodiment in which this portion of the method of FIG. 3 is carried out automatically, a good or service provider at a computer running a web browser might use the web browser to access a website at which the good or service provider is prompted to enter a survey topic under control of the survey topic identification module 110 of the software 100 of the market survey analysis system 10, as described above. As another example, in an embodiment in which this portion of the method of FIG. 3 is carried out manually, a marketing consultant might meet with a good or service provider to determine in face-to-face fashion the needs of the provider. Especially where this portion of the method of FIG. 3 is carried out manually, the marketing consultant and the provider at this time preferably define success and come to agreement as to the goals of the good or service provider.

For example, an online service provider that generates revenue by selling advertising which is displayed to users of their Internet search engine might be interested in improving the impression that their company makes on people visiting their website. Such an online service provider might enter the following as survey topic: “online help available at website of Company X.”

At block 530 of the flowchart shown in FIG. 3, a survey is conducted. For example, in the event that this portion of the method of FIG. 3 is carried out automatically, survey participants at computers running web browsers might use those web browsers to visit a website at which an online survey is administered under control of the survey administration module 120 of the software 100 of the market survey analysis system 10, as described above. An exemplary market survey in accordance with the present embodiment is described below at the description given with reference to FIG. 4.

Instructions given to survey participants at this time are preferably designed to reduce inhibition and elicit inner feelings and hidden emotions. For example, survey participants are preferably reassured that their responses will be treated confidentially and that the survey is administered in such fashion that identities of survey participants will remain anonymous. Similarly, survey participants are preferably reassured that there are no wrong answers. Survey participants are preferably encouraged to answer quickly, to say what they feel rather than what they think, to trust their gut, to cut loose, and are otherwise encouraged to go ahead and express themselves in uninhibited fashion.

Concurrent reference is now made to FIG. 4, which is a flowchart showing a method for conducting a market survey such as that indicated at block 530 in the flowchart of FIG. 3. At block 531 of the flowchart shown in FIG. 4, images are displayed to a survey participant. For example, in one embodiment, a set of 35 images might be displayed to the survey participant. In one embodiment, it is preferred that the set of images displayed to the survey participant be chosen to be content-neutral. What is meant here by content-neutral is that if the survey topic is related to cars, for example, none of the images displayed to the survey participant would be images of cars. Such content-neutral images force survey participants to explore their feelings about the survey topic rather than resort to easy, “rational” answers.

Some exemplary images from among a set of images that might be displayed to a survey participant at block 531 in a survey on the topic of online help can be seen at FIG. 5. At block 532 of the flowchart shown in FIG. 4, a survey participant is asked to select, from the set of images displayed at block 531, at least one image that the survey participant associates with a feeling or emotion that the survey participant has toward the survey topic. For example, the survey participant might be asked to select, from such a set of images, the three images that best express how the survey participant feels about the survey topic. For example, if the survey topic identified at block 510 in the flowchart of FIG. 3 is “online help available at the website of Company X,” the survey participant might be asked at block 532 in the flowchart of FIG. 4 to select three images that best express how the survey participant feels about the online help that is available at the website of Company X. In one embodiment, display and selection of images at blocks 531 and 532 is carried out under control of the image selection module 122 of the software 100 of the market survey analysis system 10, as described above.

Here, because a specific brand or company is mentioned, this pass through the flowchart of FIG. 4 is said to be concerned with what is referred to herein as a specific scenario. As described in further detail below, the operations at blocks 531 through 536 might be carried out multiple times in succession to permit survey data to be gathered for each of several alternate scenarios. For example, in a preferred embodiment, survey data might be generated for three scenarios, these being a specific scenario, a perfect (or ideal) scenario, and a typical scenario. The present description treats the case of the specific scenario. Operations carried out in subsequent passes through the flowchart of FIG. 4 for the perfect scenario and the typical scenario would be similar to operations carried out for the specific scenario, except that survey instructions for the perfect and typical scenarios would be posed not in terms of the online help available at website of Company X but in terms of the perfect or typical online help scenario, as will be described in further detail below.

At block 534, a survey participant is asked to enter emotion-expressing text that the survey participant associates with an image selected at block 532. For example, at block 534, for each of the images selected at block 532, a survey participant might be asked to enter the single word that best describes the feeling that the image expresses for the survey participant. For example, if the survey topic identified at block 510 in the flowchart of FIG. 3 is “online help available at website of Company X,” the survey participant might be asked to enter the word that best completes the following sentence: “When I think about the online help available at the website of Company X, I feel <BLANK>.” Here, <BLANK> would represent the word that should be entered by the survey participant as emotion-expressing text at block 534 in the flowchart of FIG. 4. Here, it is preferred that the response of the survey participant be filtered to avoid simplistic answers such as “good” or “bad”.

Alternatively or in addition to entry of single-word text at block 534 as described above, a survey participant might at block 534 be given free rein to enter as much emotion-expressing text as the survey participant likes for each of the images selected at block 532. For example, if the survey topic identified at block 510 in the flowchart of FIG. 3 is “online help available at website of Company X,” the survey participant might be encouraged to describe his or her feelings in verbose or elaborated fashion with instructions such as the following: “Tell us about the image that you selected. Write as much as you would like about the feeling that the image expresses for you. The more you write, the more it helps us understand your feelings. Describe your feeling in as much detail as you would like. What makes you feel this way when you think about the online help available at the website of Company X?”

In one embodiment, entry of single-word and/or elaborated text at block 534 is carried out under control of the text entry module 124 of the software 100 of the market survey analysis system 10, as described above.

At block 536, for each of the image-text combinations generated at blocks 532 and 534, an emotion intensity metric is generated that is a measure of the intensity of the emotion that the survey participant has in connection with the image selected at block 532 and the emotion-expressing text entered at block 534. Note that the survey participant need not realize at this time that what he or she is doing at block 536 is being used to generate an emotion intensity metric. For example, a survey participant might be asked directly in one embodiment to enter the intensity of his or her emotion on a scale of, for example, −6 to +6. More subtly, however, a survey participant might be asked in another embodiment to enter which among a set of emotion-intensity-measuring words best captures the emotion of the image selected at block 532 and the emotion-expressing text entered at block 534. An exemplary set of such emotion-intensity-measuring words—here being 13 words running the gamut from intense negative emotion, through low or zero emotional intensity, to intense positive emotion—might be as follows: dejected, angry, sad, disturbed, nervous, bored, indifferent, interested, confident, surprised, happy, delighted, ecstatic. In some embodiments, the emotion intensity metric might be generated directly from the image selected at block 532 and/or the emotion-expressing text entered at block 534, without the need for the survey participant to enter anything in particular at block 536. In one embodiment, generation of the emotion intensity metric at block 536 is carried out under control of the intensity metric module 126 of the software 100 of the market survey analysis system 10, as described above.

Block 537 in the flowchart of FIG. 4 is intended to indicate that the foregoing operations from block 531 through block 536 may in some embodiments be repeated in loop fashion for alternate scenarios. Data gathered for alternate scenarios in this way is helpful for providing depth and context to the responses that are received from the survey participant. In particular, data gathered in one embodiment for specific, perfect, and typical scenarios will permit graphical comparisons of the type shown in FIG. 6.

For example, if on the first pass through blocks 531 through 536 a survey participant was asked to select image(s) and enter text representative of the emotion that the survey participant has in connection with the online help available at the website of Company X, on a subsequent pass through blocks 531 through 536 the survey participant might be asked to select image(s) and enter text representative of the emotion that the survey participant has when the survey participant imagines what a perfect online help experience might be like. Here, because the perfect scenario serves as premise, this pass through the flowchart is said to be concerned with what is referred to herein as a perfect scenario.

The survey participant might be asked at block 532 to select three images that best express how the survey participant feels about the perfect online help experience. Similarly, the survey participant might be asked at block 534 to enter the one word that completes the sentence: “When I think about the perfect online help experience, I feel <BLANK>.”

Alternatively or in addition thereto, the survey participant might at block 534 be given free rein to enter as much emotion-expressing text as the survey participant likes to describe the images that he or she selected as being representative of the perfect online help experience at block 532. As was the case for the specific scenario, described above, an emotion intensity metric might be generated at block 536, e.g., by having the survey participant select from among a set of 13 emotion-intensity-measuring words, for each of the perfect-scenario image-text combinations generated at blocks 532 and 534.

As another example, on a subsequent pass through blocks 531 through 536 the survey participant might be asked to select image(s) and enter text representative of the emotion that the survey participant has when the survey participant imagines what a typical online help experience might be like. Here, because the typical scenario serves as premise, this pass through the flowchart is said to be concerned with what is referred to herein as a typical scenario.

The survey participant might be asked at block 532 to select three images that best express how the survey participant feels about the typical online help experience. Similarly, the survey participant might be asked at block 534 to enter the one word that completes the sentence: “When I think about the typical online help experience, I feel <BLANK>.” Alternatively or in addition thereto, the survey participant might at block 534 be given free rein to enter as much emotion-expressing text as the survey participant likes to describe the images that he or she selected as being representative of the typical online help experience at block 532. Furthermore, an emotion intensity metric might be generated at block 536, e.g., by having the survey participant select from among a set of 13 emotion-intensity-measuring words, for each of the typical-scenario image-text combinations generated at blocks 532 and 534.

In this way, by carrying out the operations at blocks 531 through 536 multiple times in succession, survey data consisting of images, emotion-expressing text, and emotion intensity metrics might be generated for alternate scenarios. In a preferred embodiment, survey data is generated for at least three scenarios as described above, these being a specific scenario, a perfect scenario, and a typical scenario.

At block 539 of the flowchart in FIG. 4, raw survey data is output. Note that the raw survey data output at block 539 in the flowchart of FIG. 4 has not yet been coded by emotionally based theme.

Returning now to the flowchart of FIG. 3, at block 550 of this flowchart, one or more, preferably on the order of five, emotionally based themes are extracted from the raw survey data output at block 539 in the flowchart of FIG. 4. Extraction of emotionally based themes at block 550 in the flowchart of FIG. 3 may be carried out entirely automatically, may be carried out entirely manually, or may be carried out partially automatically and partially manually. For example, in an embodiment in which block 550 in the flowchart of FIG. 3 is carried out automatically, the raw survey data output at block 539 in the flowchart of FIG. 3 might be subjected to semantic analysis under the control of the emotionally based theme extraction module 130 of the software 100 of the market survey analysis system 10, as described above. As another example, in an embodiment in which block 550 in the flowchart of FIG. 3 is carried out manually, extraction of emotionally based themes might be facilitated by enlisting the cooperation of human beings charged with the task of finding emotionally based themes present in the market survey data.

In a preferred embodiment where such extraction of emotionally based themes is facilitated by enlisting the cooperation of human beings, a plurality of teams might each meet after the fashion of a focus group or jury to collectively construct a narrative that relates the message that team members garner from the images selected and the text entered by survey participants at blocks 532 and 534 in the flowchart of FIG. 4, and respective teams might then compare their respective narratives with those of other teams having contrasting views.

Each such team might contain, for example, seven members who are given, for example, 20 candidate emotionally based themes tentatively extracted, for example, by semantic analysis from the raw survey data output at block 539 in the flowchart of FIG. 4, as well as materials such as foam board and on the order of 75 images similar to the images displayed at block 531 in the flowchart of FIG. 4, together with on the order of 50 variants on a “what if” motif that might, for example, include ideas on how to improve the good or service in question. In such a case, these teams would furthermore be charged with the task of distilling the 20 or so candidate emotionally based themes down to, for example, five emotionally based themes, and also with the task of assembling a collage from the foam board and images, or otherwise constructing a narrative that relates in verbal and/or pictorial fashion the message that the team members garnered from the images selected and the text entered by survey participants at blocks 532 and 534 in the flowchart of FIG. 4. Whether carried out automatically or manually, a suitable number, e.g., five, emotionally based themes are extracted at block 550 in the flowchart in FIG. 3 from the raw survey data output at block 539 in the flowchart of FIG. 4.

At block 570 of the flowchart in FIG. 3, the market survey data from block 539 in the flowchart of FIG. 4 is coded by the emotionally based themes extracted at block 550 in the flowchart of FIG. 3. What is meant here by coding is that each response from each survey participant, i.e., each image-text combination from the survey conducted at block 530 of the flowchart in FIG. 3, is categorized as corresponding to one of the emotionally based themes extracted at block 550 in the flowchart of FIG. 3. For example, if “hugged,” “in control,” “adept,” “centered,” and “unique” were extracted as emotionally based themes at block 550 in the flowchart of FIG. 3, each response from each survey participant would be categorized as reflecting one of these five emotionally based themes. In one embodiment, this coding of survey data is carried out under control of the data coding module 140 of the software 100 of the market survey analysis system 10. A partial example of the result of such coding can be seen in the tabular listing shown in FIG. 5, where emotionally based themes 740 appear in the rightmost column.

At block 590 of the flowchart in FIG. 3, coded survey data is output. Market survey data from the market survey conducted at block 530 that has been coded at block 570 by the emotionally based themes extracted at block 550 is output at block 590 in the flowchart of FIG. 3. Output of coded data at this time may be carried out under control by the results presentation module 150 of the software 100 of the market survey analysis system 10.

For example, during output of coded market survey data at block 590 in the flowchart of FIG. 3, the tabular listing module 152 of the results presentation module 150 may produce output in tabular listing format 700 such as is shown by way of example in FIG. 5. At the exemplary tabular listing format 700 shown in FIG. 5, survey responses are shown for two survey participants, these being respectively identified by unique survey participant numbers 705. In the example shown in FIG. 5, each survey participant 705 selected three images 710 at block 532 in the flowchart of FIG. 4, and each of the images 710 selected by a survey participant 705 is shown in a row of the tabular listing 700 together with the single-word emotion-expressing text 720 and the elaborated emotion-expressing text 725 entered by the survey participant 705 at block 534 in the flowchart of FIG. 4.

Also shown in the same row as the selected image 710 and emotion-expressing text 720, 725 is an emotion-intensity-measuring word 730. For example, the emotion-intensity-measuring word 730 might be a word selected by the survey participant at block 536 in the flowchart of FIG. 4 from among an exemplary set of 13 emotion-intensity-measuring words, as described above. Furthermore, listed immediately to the right of this emotion-intensity-measuring word 730 in the present example is a numerical emotion intensity metric 735 into which this emotion-intensity-measuring word 730 has been converted at block 536 in the flowchart of FIG. 4. For example, the range of emotional intensity covered by the set of 13 exemplary emotion-intensity-measuring words described above might be mapped onto a scale that runs from −6 to +6 for use as the range of the emotion intensity metric 735 shown in FIG. 5.

Also shown at the rightmost column in the tabular listing online survey FIG. 5 is an emotionally based theme 740, this being the emotionally based theme that of the emotionally based themes extracted at block 550 in the flowchart of FIG. 3 best applies to the image 710 and emotion-expressing text 720, 725 in that row of the tabular listing 700. Note that the exemplary tabular listing 700 shown in FIG. 5 is a partial listing of typical-scenario responses to a market survey conducted on the topic of online help; specific-scenario and perfect-scenario market survey responses might likewise be output in tabular listing format.

As another example of output of coded market survey data at block 590 in the flowchart of FIG. 3, the graphical comparison module 154 of the results presentation module 150 may produce output in graphical comparison format 800 such as is shown by way of example in FIG. 6. At the exemplary graphical comparison format 800 shown in FIG. 6, five emotionally based themes 740 extracted from the market survey data at block 550 in the flowchart of FIG. 3 are listed in the leftmost column. Next to each emotionally based theme 740 there are, in the present example, four rows respectively corresponding to four scenarios 752, 754, 756, 758 for which the market survey was conducted. Three of these four scenarios are the three scenarios referred to above in the description given with reference to the flowchart of FIG. 4, these being a specific scenario (“Company X online help”) 752, a typical scenario (“typical online help”) 754, and a perfect scenario (“perfect online help”) 756. In the present example, the market survey was also conducted for a fourth scenario, this being an unqualifiedly perfect scenario (“perfect help, regardless of whether online or not”) 758, which is shown together with the other three scenarios next to each emotionally based theme 740 in the graphical comparison 800 of FIG. 6.

At the bottom of the exemplary graphical comparison 800 shown in FIG. 6, an emotion intensity scale 760 divides responses into a negative emotion region 770 containing responses for which the emotion intensity metric 735 generated at block 536 in the flowchart of FIG. 4 reflects negative emotion, and a positive emotion region 780 containing responses for which the emotion intensity metric 735 generated at block 536 in the flowchart of FIG. 4 reflects positive emotion. At FIG. 6, for each scenario 752, 754, 756, 758 at each emotionally based theme 740, survey participant responses are furthermore graphed on this emotion intensity scale 760 so as to provide a visual indication of the emotional character of those responses.

For purposes of the description given below, it will be assumed that the emotion intensity metric is a number from −6 to +6, an emotion intensity metric of 0 indicating indifference, a negative emotion intensity metric indicating negative emotion, and a positive emotion intensity metric indicating positive emotion.

For example, as shown by way of example in FIG. 6, responses reflecting negative emotion as indicated by the emotion intensity metric 735 generated at block 536 in the flowchart of FIG. 4 might be represented in graphical form on the negative side 770 of the emotion intensity scale 760 by a two-shaded bar having a light portion 771 and a dark portion 772. This two-shaded bar indicating negative emotion might be such that the length of the light portion 771 corresponds to the number of responses for which the emotion intensity metric 735 was between 0 and −3 (signifying weak emotional intensity), and the length of the dark portion 772 corresponds to the number of responses for which the emotion intensity metric 735 was between −3 and −6, (signifying strong emotional intensity) with the combined length of the light and dark portions 771, 772 corresponding to the number of responses for which the emotion intensity metric 735 was negative, this number 774 of responses for which the emotion intensity metric 735 was negative being indicated to the side of the negative emotion bar.

Similarly, responses reflecting positive emotion as indicated by the emotion intensity metric 735 generated at block 536 in the flowchart of FIG. 4 might be represented in graphical form on the positive side 780 of the emotion intensity scale 760 by a two-shaded bar having a light portion 781 and a dark portion 782. This two-shaded bar indicating positive emotion might be such that the length of the light portion 781 corresponds to the number of responses for which the emotion intensity metric 735 was between 0 and +3 (signifying weak emotional intensity), and the length of the dark portion 782 corresponds to the number of responses for which the emotion intensity metric 735 was between +3 and +6 (signifying strong emotional intensity), with the combined length of the light and dark portions 781, 782 corresponding to the number of responses for which the emotion intensity metric 735 was positive, this number 784 of responses for which the emotion intensity metric 735 was positive being indicated to the side of the positive emotion bar.

Although the foregoing description has been carried out in terms of two-shaded emotion bars respectively subdividing negative and positive responses into two levels of emotional intensity (e.g., weak emotional intensity versus strong emotional intensity), there is no particular objection to employment of three-shaded emotion bars or other such multi-shaded emotion bars respectively subdividing responses into any desired number of levels of emotional intensity.

Graphical comparison 800 such as that shown in FIG. 6 makes it possible to easily see how a specific experience, e.g., online help provided by Company X, compares with what survey participants view as typical or perfect experiences, for example, for each of the emotionally based themes 740 extracted at block 550 in the flowchart of FIG. 3. Such emotion-based comparative studies can be of great value to producers of goods and services, for example, who desire to understand how they are perceived relative to their competitors or relative to what is perceived to be typical or perfect by survey participants. For example, graphical comparisons 800 such as that shown in FIG. 6 allow a producer of a good or service to see where its brand is emotively strong or weak relative to its competitors, its category, and even an imagined perfect version of the good or service. Graphical comparisons 800 such as that shown in FIG. 6 frequently reveal what survey participants want—even when the survey participants themselves are not consciously aware of what they want.

Alternatively or in addition to output in tabular listing format 700 by the tabular listing module 152 and/or output in graphical comparison format 800 by the graphical comparison module 154, the executive summary module 156 of the results presentation module 150 may produce an executive summary of exemplary format as described above. In one embodiment, semantic analysis might, for example, be employed to derive content as required for such an executive summary from emotion-expressing text 720, 725 entered by survey participants at block 534 and/or emotion-intensity-measuring words and/or numbers entered and/or generated at block 536 in the flowchart of FIG. 4, and/or emotionally based themes 740 extracted from market survey data at block 550 in the flowchart of FIG. 3. In some embodiments, enlisting the cooperation of human beings charged with this task might facilitate preparation of such an executive summary.

In one embodiment, unusual or provocative terms are preferably employed for the emotionally based themes 740 as presented for final output by, for example, the results presentation module 150. The terms obtained as a result of extraction, for example as carried out by semantic analysis, at block 550 in the flowchart of FIG. 3, might be relatively non-provocative-sounding terms such as “protected,” “paternal,” and “capable,” these being listed as examples of emotionally based themes 740 at the rightmost column in the tabular listing 700 of FIG. 5. However, to better communicate the emotive responses of market survey participants as well as foster empathic understanding and new insights in market survey analysis recipients, provocative, unusual, and/or interesting-sounding terms such as “hugged,” “in control,” “adept,” “centered,” and “unique,” these being listed as examples of emotionally based themes 740 at the leftmost column in the graphical comparison 800 of FIG. 6, might be employed in the final output by the results presentation module 150. In one embodiment, selection of appropriately provocative terms as emotionally based themes 740 might be facilitated by enlisting the cooperation of marketing consultants or other human beings charged with the task.

As described above, market survey analysis systems and methods in accordance with various aspects and embodiments of the present invention solve one or more of the problems mentioned above, and may also provide other advantages and benefits. For example, the system and method of the present invention as described above may be useful to a good or service provider interested in developing a new product, brand, or service. As another example, the system and method of the present invention may help cut product development time. Furthermore, the system and method of the present invention may be useful when launching a new marketing strategy or ad campaign, may help eliminate false starts, and may help all parties involved create and accept more innovative work.

The system and method of the present invention can help reveal why a previously successful product, brand, or service is no longer as popular as it used to be. The system and method of the present invention is especially useful in situations where a new product fails despite the fact that focus groups had shown great liking for the product, or in situations where a good or service provider fears that they may be missing some crucial piece of information about the people they serve. For example, the system and method of the present invention can be useful when a good or service provider has a poor understanding of the emotionally based themes that propel or inhibit purchases. The system and method of the present invention may be helpful where a good or service provider needs to decide whether to terminate or resuscitate a troubled brand. Moreover, the system and method of the present invention may be useful when a good or service provider seeks fresh inspiration, a clean space for innovation, or is otherwise interested in getting to know in an entirely new way the people to whom they are selling.

Although the example of a good or service provider interested in better understanding the emotions that are linked to purchasing decisions by potential or actual purchasers has been given above, the present invention is not limited to uncovering of emotions linked to purchasing decisions, and providers of goods and services are not the only ones interested in understanding this linkage. The system and method of the present invention may be advantageously employed to uncover emotions of people in a great many situations and under a wide variety of circumstances. For example, a policy maker might be interested in understanding how his or her constituency feels about the economy. The system and method of the present invention can help uncover emotionally based themes in connection with such topics as well.

It should be emphasized that the above-described embodiments of the present invention are merely possible examples of implementations, merely set forth for a clear understanding of the principles of the invention. Many variations and modifications may be made to the above-described embodiments of the invention without departing substantially from the spirit and principles of the invention.

What is claimed is:

1. A method for conducting a market survey, comprising the steps of:
identifying a survey topic;
administrating a survey on the survey topic to a survey participant, wherein administering the survey comprises:
requesting the survey participant to enter emotion expressing text, and
requesting the survey participant to enter a first emotion-intensity measuring metric, wherein the first emotion-intensity measuring metric relates the emotional response level of the survey participant to the emotion expressing text;
accepting a survey entry by the survey participant, wherein the survey entry comprises:
the emotion expressing text, and
the first emotion-intensity measuring metric;
correlating an emotionally based theme to the emotion expressing text; and
assigning a second emotion-intensity measuring metric to the emotionally based theme based upon the first emotion-intensity measuring metric.

2. The method of claim 1, wherein administering the survey further comprises the steps of:
displaying a predetermined set of images to the survey participant; and
requesting the survey participant to select an image from the predetermined set of images.

3. The method of claim 1, wherein the survey entry further comprises an image selected from the predetermined set of images.

4. The method of claim 1, wherein requesting the survey participant to enter emotion expressing text further comprises the step of presenting a predetermined set of emotion expressing text to the survey participant.

5. The method of claim 1, wherein the second emotion-intensity measuring metric comprises a number in the range from −6 to +6.

6. The method of claim 1, wherein the second emotion-intensity measuring metric comprises a number in the range from −10 to +10.

7. The method of claim 1, wherein the first emotion-intensity measuring metric comprises a word.

8. The method of claim 7, wherein the word is selected from the group consisting of dejected, angry, sad, disturbed, nervous, bored, indifferent, interested, confident, surprised, happy, delighted, and ecstatic.

9. The method of claim 1, wherein administering the survey further comprises the steps of:
asking a survey question regarding the survey topic in relation to an ideal market scenario;
asking a survey question regarding the survey topic in relation to a typical market scenario; and
asking a survey questions regarding the survey topic in relation to a specific market scenario.

10. The method of claim 1, wherein requesting the survey participant to enter emotion expressing text further comprises the step of displaying a fill-in-the-blank statement to the survey participant.

11. The method of claim 10, wherein the emotion expressing text comprises a word.

12. A method for conducting a market survey and processing the resulting data, comprising the steps of:
determining a survey topic;
collecting survey data;
extracting an emotionally based theme from the survey data;
coding the survey data based upon the emotionally based theme; and
outputting coded results.

13. The method of claim 12, wherein collecting survey data further comprises the steps of:
requesting a survey participant to enter emotion expressing text;
requesting a survey participant to generate an emotion intensity metric; and
outputting raw data.

14. The method of claim 13, wherein collecting survey data further comprises the steps of displaying images and requesting a survey participant to select an image from the displayed images.

15. A computer readable medium configured to perform steps comprising:
identifying a survey topic;
administrating a survey on the survey topic to a survey participant, wherein administering the survey comprises:
requesting the survey participant to enter emotion expressing text, and
requesting the survey participant to enter a first emotion-intensity measuring metric, wherein the first emotion-intensity measuring metric relates the emotional response level of the survey participant to the emotion expressing text;
accepting a survey entry by the survey participant, wherein the survey entry comprises:
the emotion expressing text, and
the first emotion-intensity measuring metric;
correlating an emotionally based theme to the emotion expressing text; and
assigning a second emotion-intensity measuring metric to the emotionally based theme based upon the first emotion-intensity measuring metric.

16. The computer readable medium of claim 15, wherein administering the survey further comprises the steps of:
displaying a predetermined set of images to the survey participant; and
requesting the survey participant to select an image from the predetermined set of images.

17. A computer readable medium configured to perform steps comprising:
determining a survey topic;
collecting survey data;
extracting an emotionally based theme from the survey data;
coding the survey data based upon the emotionally based theme; and
outputting coded results.

18. The computer readable medium of claim 17, wherein collecting survey data further comprises the steps of:
requesting a survey participant to enter emotion expressing text;
requesting a survey participant to generate an emotion intensity metric; and
outputting raw data.

19. The computer readable medium of claim 18, wherein collecting survey data further comprises the steps of displaying images and requesting a survey participant to select an image from the displayed images.

20. A system for collecting, processing and presenting market survey data relating the emotional response of a survey participant to a survey topic comprising:
a survey topic identification module;
a survey administration module comprising:
a text entry module wherein the survey participant enters text representing an emotion expressing text, and
an emotion intensity metric module wherein the survey participant enters a first emotional intensity metric;
an emotionally based theme extraction module wherein the emotionally based theme extraction module associates an emotionally based theme with the emotion expressing text, the emotionally based theme being selected from a predetermined list of emotionally based themes;
a data coding module wherein a second emotional intensity metric is assigned to the emotionally based theme based upon the emotion expressing text and the first emotion intensity metric; and
a results presentation module.

21. The system of claim 20, wherein the survey administration module further comprises an image selection module wherein the survey participant selects an image from a predetermined set of images.

22. The system of claim 20, wherein the first emotional intensity metric comprises a numeric value indicating the intensity of emotion associated with the emotion expressing text.

23. The system of claim 20, wherein the first emotional intensity metric comprises a text description of the intensity of emotion associated with the emotion expressing text.

24. The system of claim 20, wherein the results presentation module comprises a tabular listing module.

25. The system of claim 20, wherein the results presentation module comprises a graphical comparison module.

26. The system of claim 20, wherein the results presentation module comprises an executive summary module.
